(19) United States
(12) Patent Application Publication
(10) Pub. No.: US 2018/0083362 A1
(43) Pub. Date: Mar. 22, 2018

(54) SLOT ANTENNA

(71) Applicant: National Chi Nan University, Nantou County (TW)

(72) Inventors: Wei-Chung Weng, Taichung (TW); Min-Chi Chang, Yunlin County (TW)

(21) Appl. No.: 15/377,171

(22) Filed: Dec. 13, 2016

(30) Foreign Application Priority Data
Sep. 20, 2016 (TW) 105130288

(51) Int. Cl. H01Q 13/10; H01Q 1/48

(52) U.S. Cl. CPC H01Q 13/106; H01Q 1/48

(57) ABSTRACT

A slot antenna comprises a substrate, an antenna portion and a feed-in portion. The substrate is provided with an upper surface and a lower surface corresponding to the upper surface. The antenna portion comprises a ground layer on the upper surface, and an irregular polygonal slot passing through the ground layer and surrounded by the ground layer. The irregular polygonal slot is provided with end points forming slot edges therebetween. The location of each end point is computed via an optimization algorithm so as to be predefined, such that the slot edges are not arranged in a regular orientation. The feed-in portion comprises a fed line on the lower surface. The location of each end point is planned automatically via the optimization algorithm so as to manufacture the irregular polygonal slot, such that a more simplified design procedure and a relatively simple structure are achieved for the slot antenna.

### FIELD OF THE INVENTION

The present invention is related to a slot antenna, particularly to a slot antenna with simplified design procedure and simple structure.

### BACKGROUND OF THE INVENTION

As electronic products develop, an antenna has become one of indispensable components for many electronic devices. The further improvement, however, on the structure of the antenna is made by many industries to enable the antenna having better efficiency of transmission.

For instance, U.S. Pat. No. 7,006,048 B2 proposed a dual operational frequency slot antenna for receiving/transmitting wireless signals from a satellite or for receiving/transmitting wireless signals in an RFID system, comprising a F-type slot antenna for receiving and transmitting a wireless signal at a first working frequency and a wireless signal at a second working frequency; and a fed line for receiving and transmitting the wireless signals at the first working frequency and the second working frequency, wherein the F-type slot antenna is composed of two L-type slot antennas, and the fed line is a metal line and made of printed circuit.

In the above prior art, the antenna is mostly designed by trial-and-error approach, and the structure of antenna is mostly extended in a regular manner. The complicated design procedure and the complex structure of the antenna occur readily, as well as difficulty in manufacture is further increased, however, due to the way used for designing and the limitation on structure in the above.

### SUMMARY OF THE INVENTION

It is the main object of the present invention to solve the problem of difficulty in designing the conventional antenna.

For achieving the above object, the present invention provides a slot antenna comprising a substrate, an antenna portion and a feed-in portion. The substrate is provided with an upper surface and a lower surface corresponding to the upper surface. The antenna portion comprises a ground layer provided on the upper surface, and an irregular polygonal slot passing through the ground layer and surrounded by the ground layer. The irregular polygonal slot is provided with a plurality of end points forming a plurality of slot edges therebetween. The location of each end point is computed via an optimization algorithm so as to be predefined, such that the slot edges are not arranged in a regular orientation. The feed-in portion comprises a fed line provided on the lower surface.

It is known from the above that, in comparison with the prior art, the effects to be achieved by the present invention are as follows. The optimization algorithm is adopted in this disclosure to define the shape of the irregular polygonal slot. In this connection, only computing is required, without relying on experience of the designer, in the design procedure of antenna. Moreover, the irregular polygonal slot designed via the optimization algorithm should not be intentionally extended in the manner of regular shape. Therefore, relatively lower difficulty in manufacture with relatively higher freedom in design of the slot antenna of this disclosure is achieved.

### BRIEF DESCRIPTION OF THE DRAWINGS

FIG. 1 is a top diagram of the slot antenna of a first embodiment of the present invention.

FIG. 2 is a cross-section diagram along direction A-A of FIG. 1.

FIG. 3 is a top diagram of the slot antenna of a second embodiment of the present invention.

FIG. 4 is a top diagram of the slot antenna of a third embodiment of the present invention.

FIG. 5A is a frequency response graph of reflection coefficient of the slot antenna of the first embodiment of the present invention.

FIG. 5B is a frequency response graph of axial ratio of the slot antenna of the first embodiment of the present invention.

FIG. 5C is a radiation pattern graph in the x-z plane of the slot antenna of the first embodiment of the present invention.

FIG. 5D is a radiation pattern graph in the y-z plane of the slot antenna of the first embodiment of the present invention.

FIG. 6A is a frequency response graph of reflection coefficient of the slot antenna of the second embodiment of the present invention.

FIG. 6B is a frequency response graph of axial ratio of the slot antenna of the second embodiment of the present invention.

FIG. 6C is a radiation pattern graph in the x-z plane of the slot antenna of the second embodiment of the present invention.

FIG. 6D is a radiation pattern graph in the y-z plane of the slot antenna of the second embodiment of the present invention.

FIG. 7A is a frequency response graph of reflection coefficient of the slot antenna of the third embodiment of the present invention.

FIG. 7B is a frequency response graph of axial ratio of the slot antenna of the third embodiment of the present invention.

FIG. 7C is a radiation pattern graph in the x-z plane of the slot antenna of the third embodiment of the present invention.

FIG. 7D is a radiation pattern graph in the y-z plane of the slot antenna of the third embodiment of the present invention.

### DETAILED DESCRIPTION OF THE PREFERRED EMBODIMENTS

The detailed description and technical solution with respect to the present invention will be now described in conjunction with the drawings as follows.

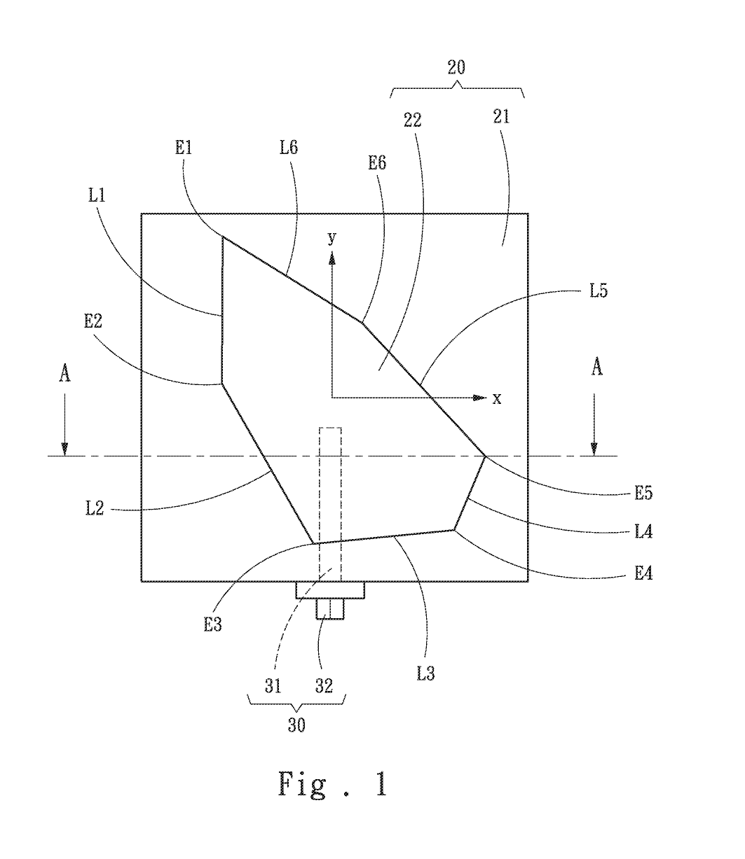

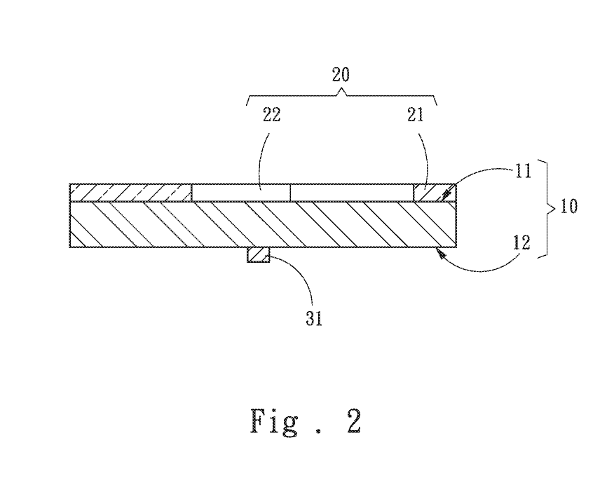

Referring to FIG. 1 together with FIG. 2, there are shown a top diagram of the slot antenna of a first embodiment of the present invention and a cross-section diagram along direction A-A of FIG. 1, respectively. The present invention is related to a slot antenna comprising a substrate 10, an antenna portion 20 and a feed-in portion 30. The substrate 10 is provided with an upper surface 11 and a lower surface 12 corresponding to the upper surface 11. In the present invention, the substrate 10 may be a glass fiber substrate or a ceramic substrate, in which the glass fiber may be in compliance with FR4 specification, while the substrate 10 may be shaped as a rectangle, circle or triangle. The category, specification and shape indicated for the substrate 10 are only exemplary, and not limited thereto.

The antenna portion 20 comprises a ground layer 21 and an irregular polygonal slot 22. The ground layer 21 is provided on the upper surface 11, in which the ground layer 21 is a thin layer of metal. The irregular polygonal slot 22 is provided with a plurality of end points forming a plurality of slot edges therebetween. In this case, the location of each end point is computed via an optimization algorithm so as to be predefined, such that the slot edges are not arranged in a regular orientation. In the present invention, the irregular polygon refers to a polygon arranged in a two-dimensional plane without a specific regularity, such as a polygon with unequal edge lengths and included angles. On the contrary, the arrangement in a regular orientation refers to a polygon or circle with symmetry and a regular arrangement, or an arrangement extended in a rectangular manner. In the present invention, the optimization algorithm may be Particle Swarm Optimization (abbreviated as PSO), Genetic Algorithm (abbreviated as GA), Ant Colony Optimization (abbreviated as, ACO), Invasive Weed Optimization (abbreviated as IWO), Artificial Neural Network (abbreviated as ANN), Design of Experiments (abbreviated as DOE) or Differential Evolution (abbreviated as DE). In one embodiment, the number of the end points is in the range from 3 to 20. In one preferred embodiment, the number of the end points is in the range from 5 to 8.

The feed-in portion 30 comprises a fed line 31, which is provided on the lower surface 12. The fed line 31 is a thin layer of metal, and may be of the kind of a microstrip-fed line or a coplanar waveguide-fed line. In the present embodiment, the feed-in portion 30 further comprises a SMA connector 32 provided at one side of the substrate 10, while electrically connected to one end of the fed line 31 far away from the irregular polygonal slot 22 and to the ground layer 21, respectively.

In the present embodiment, the number of the end points being six is taken for example. Moreover, the computation of optimization algorithm is used, such that the irregular polygonal slot 22 is defined in the x-y coordinate plane by a first end point E1, a second end point E2, a third end point E3, a fourth end point E4, a fifth end point E5 and a sixth end point E6, respectively, while a first slot edge L1 is formed between the first end point E1 and the second end point E2, a second slot edge L2 is formed between the second end point E2 and the third end point E3, a third slot edge L3 is formed between the third end point E3 and the fourth end point E4, a fourth slot edge L4 is formed between the fourth end point E4 and the fifth end point E5, a fifth slot edge L5 is formed between the fifth end point E5 and the sixth end point E6, and a sixth slot edge L6 is formed between the sixth end point E6 and the first end point E1, respectively. In this case, the coordinates of the first end point E1 are (−19.52, 30), the coordinates of the second end point E2 are (−18.75, 3.03), the coordinates of the third end point E3 are (−2.76, −26.5), the coordinates of the fourth end point E4 are (19.99, −23.28), the coordinates of the fifth end point E5 are (25.78, −9.94), and the coordinates of the sixth end point E6 are (2.88, 15.06). The coordinates of these end points are measured in millimeters (mm) In this connection, the first slot edge L1, the second slot edge L2, the third slot edge L3, the fourth slot edge L4, the fifth slot edge L5 and the sixth slot edge L6 are all of different lengths.

Referring to FIG. 3 together, there is shown a top diagram of the slot antenna of a second embodiment of the present invention. The number of the end points being six is equally taken for example in this embodiment. The shape of the irregular polygonal slot 22 found via the optimization algorithm is not always unchanged in each computation in the case of the same number of the end points, such that the locations of the end points of the present embodiment and those of the first embodiment are not the same. The irregular polygonal slot 22 is defined in the x-y coordinate plane by a first end point E1 at coordinates (−2.01, 22.02), a second end point E2 at coordinates (−11.04, 2.12), a third end point E3 at coordinates (−15.97, −23.45), a fourth end point E4 at coordinates (2.01, −17.26), a fifth end point E5 at coordinates (15.74, −5.67), and a sixth end point E6 at coordinates (16.0, 23.29), respectively. In this case, the coordinates of these end points are measured in millimeters (mm) The description of other structural features of this embodiment is similar to that of the first embodiment, and then should not be described further.

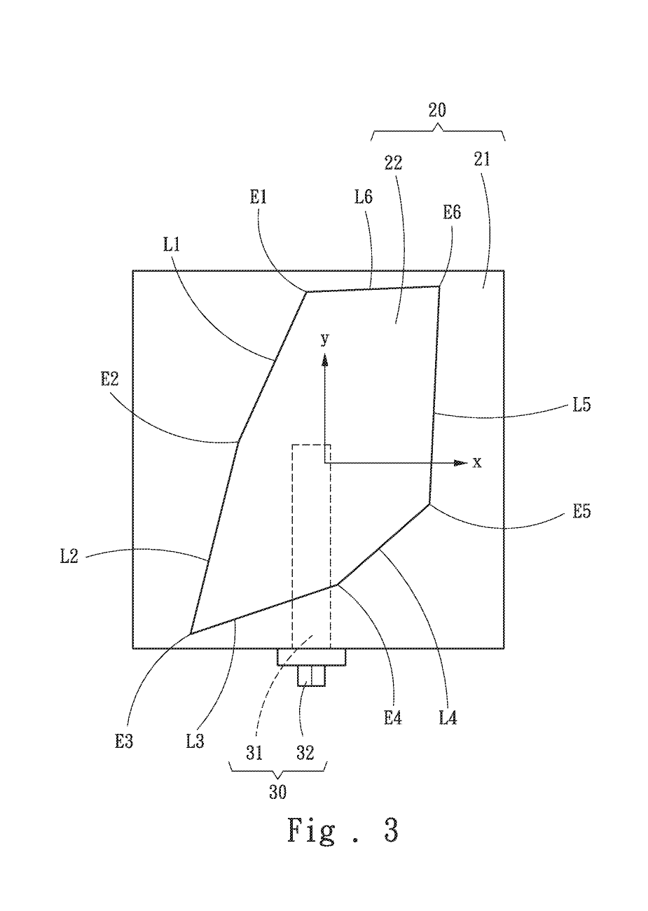

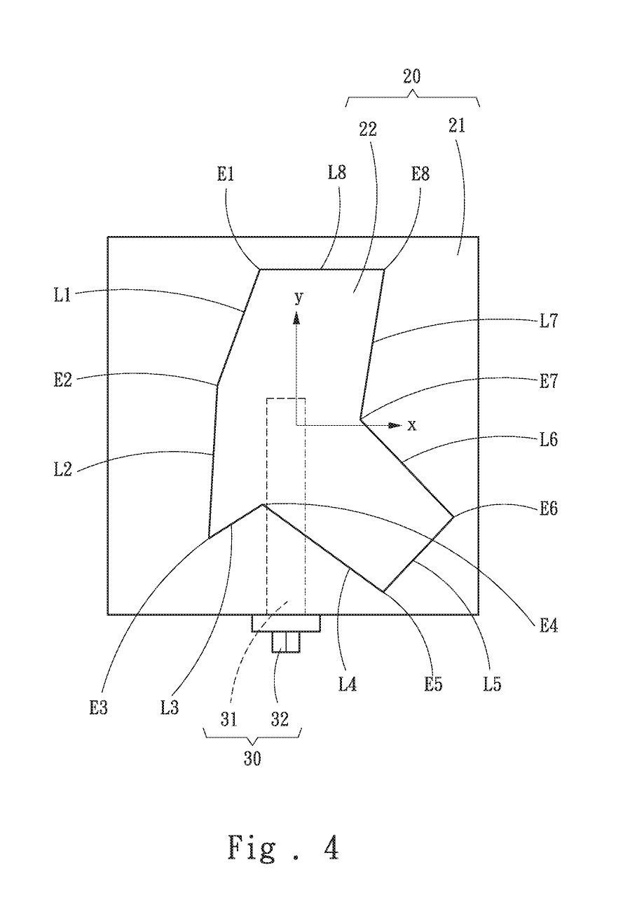

Referring to FIG. 4 together, there is shown a top diagram of the slot antenna of a third embodiment of the present invention. The number of the end points being eight is taken for example in this embodiment, and the optimization algorithm is used, such that the irregular polygonal slot 22 is defined in the x-y coordinate plane by a first end point E1 at coordinates (−4.34, 21.98), a second end point E2 at coordinates (−9.26, 7.64), a third end point E3 at coordinates (−9.20, −12.88), a fourth end point E4 at coordinates (−2.24, −9.95), a fifth end point E5 at coordinates (12.94, −21.01), a sixth end point E6 at coordinates (22.0, −10.61), a seventh end point E7 at (9.14, 1.63), and an eighth end point E8 at (12.64, 21.89), respectively. The coordinates of these end points are measured in millimeters (mm) In this case, a first slot edge L1 is formed between the first end point E1 and the second end point E2, a second slot edge L2 is formed between the second end point E2 and the third end point E3, a third slot edge L3 is formed between the third end point E3 and the fourth end point E4, a fourth slot edge L4 is formed between the fourth end point E4 and the fifth end point E5, a fifth slot edge L5 is formed between the fifth end point E5 and the sixth end point E6, a sixth slot edge L6 is formed between the sixth end point E6 and the seventh end point E7, a seventh slot edge L7 is formed between the seventh end point E7 and the eighth end point E8, and an eighth slot edge L8 is formed between the eighth end point E8 and the first end point E1, respectively. In this connection, the first slot edge L1, the second slot edge L2, the third slot edge L3, the fourth slot edge L4, the fifth slot edge L5, the sixth slot edge L6, the seven slot edge L7 and the eighth slot edge L8 are all of different lengths.

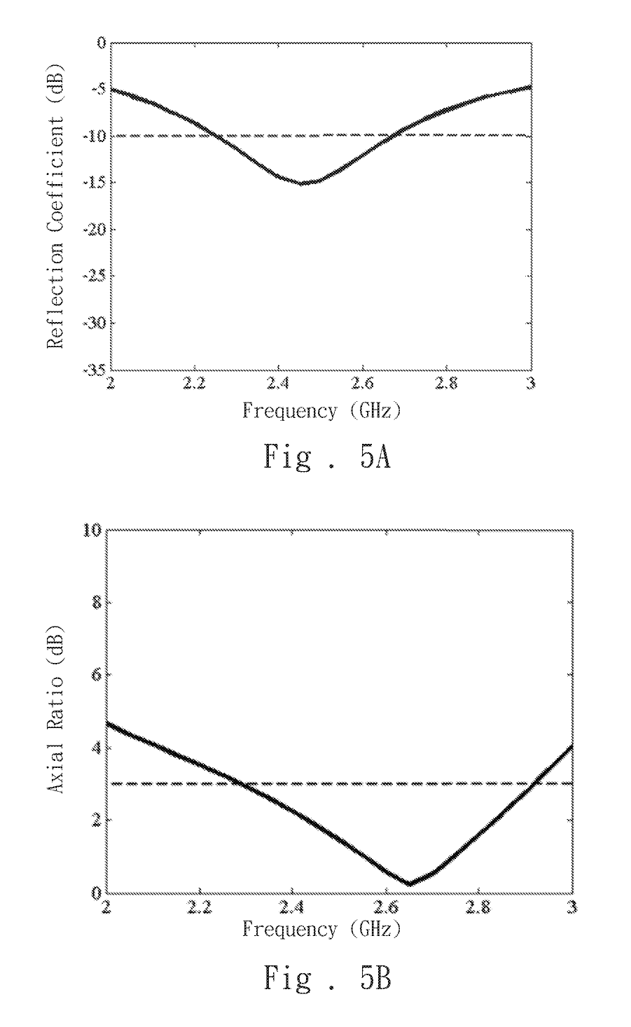

Referring to FIGS. 5A to 5D, there are shown a frequency response graph of reflection coefficient, a frequency response graph of axial ratio, a radiation pattern graph in the x-z plane, and a radiation pattern graph in the y-z plane, respectively, of the slot antenna of the first embodiment of the present invention. It is known from FIGS. 5A and 5B that impedance bandwidth of reflection coefficient (S11) lower than −10 dB is in the range from 2.25 GHz to 2.68 GHz (17.6%), while the axial radiation bandwidth (ARBW) of axial ratio (abbreviated as AR) lower than 3 dB is in the range from 2.1 GHz to 2.82 GHz (29.27%). Additionally, it is known from FIGS. 5C and 5D that radiation of the slot antenna is bi-directional. The left-handed circularly polarized (LHCP) wave may be generated by the slot antenna in the region of z>0, while the right-handed circularly polarized (RHCP) wave may be generated by the slot antenna in the region of z<0, with circular polarization bandwidth (abbreviated as CPBW) being in the range from 2.25 GHz to 2.68 GHz (17.6%).

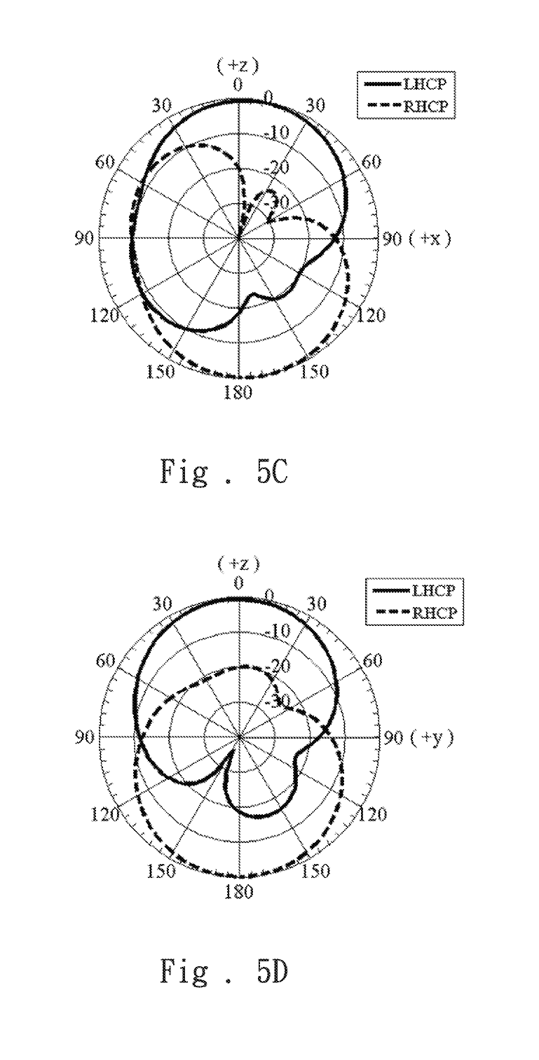

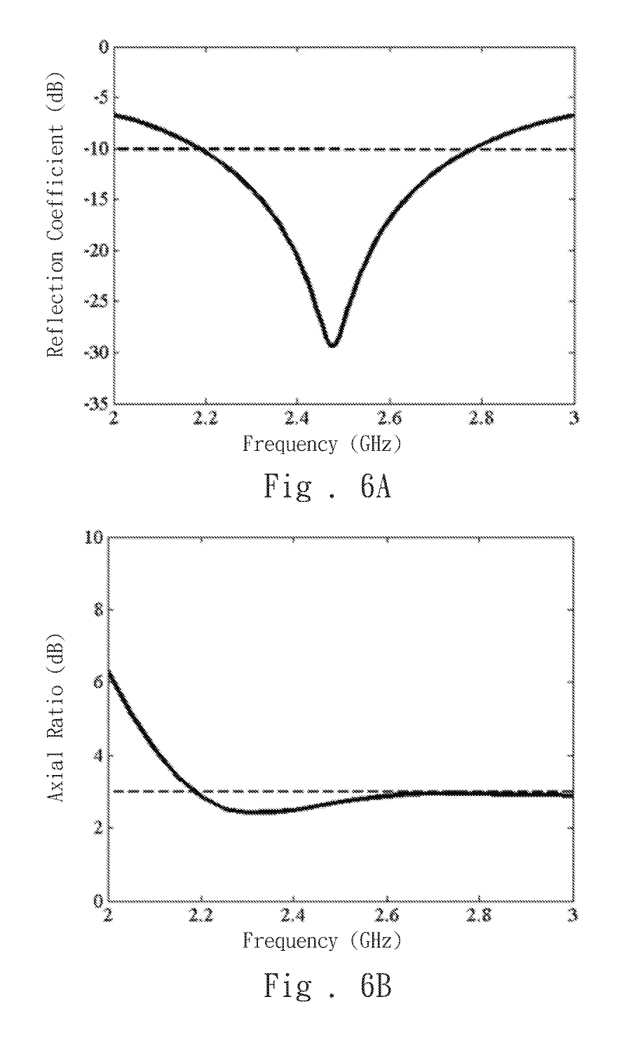

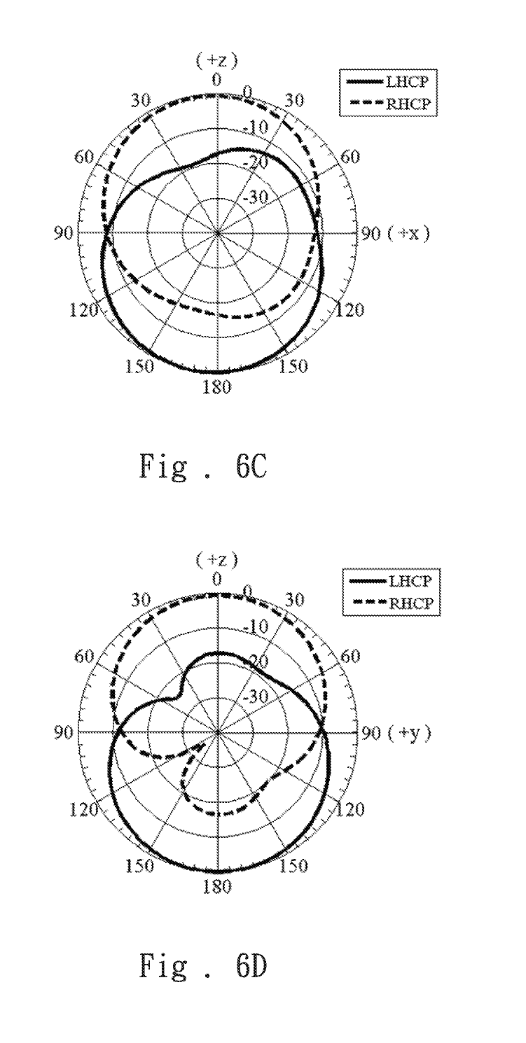

Referring to FIGS. 6A to 6D, there are shown a frequency response graph of reflection coefficient, a frequency response graph of axial ratio, a radiation pattern graph in the x-z plane, and a radiation pattern graph in the y-z plane, respectively, of the slot antenna of the second embodiment of the present invention. It is known from FIGS. 6A and 6B that impedance bandwidth of reflection coefficient lower than −10 dB is in the range from 2.2 GHz to 2.8 GHz (24.0%), while the axial radiation bandwidth of axial ratio lower than 3 dB is in the range from 2.18 GHz to 3.0 GHz (31.66%). Additionally, it is known from FIGS. 6C and 6D that radiation of the slot antenna is bi-directional. The right-handed circularly polarized wave may be generated by the slot antenna in the region of z>0, while the left-handed circularly polarized wave may be generated by the slot antenna in the region of z<0, with circular polarization bandwidth being in the range from 2.2 GHz to 2.8 GHz (24.0%).

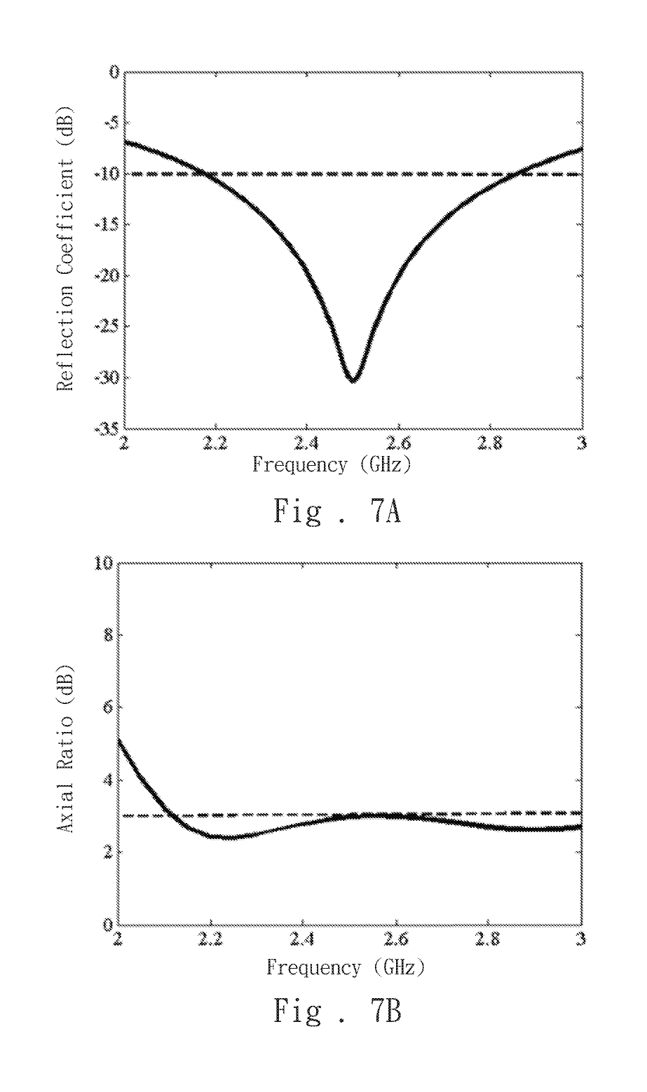

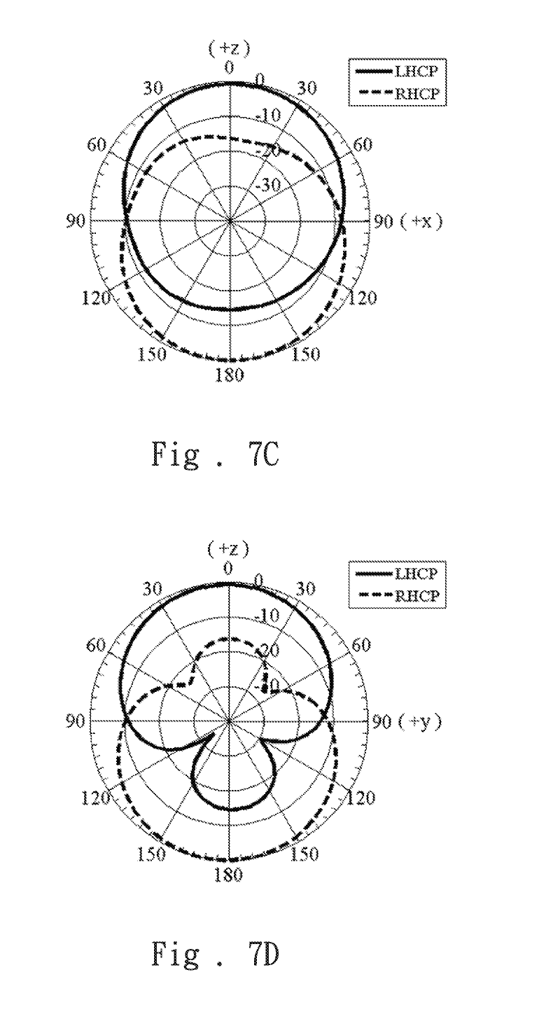

Referring to FIGS. 7A to 7D, there are shown a frequency response graph of reflection coefficient, a frequency response graph of axial ratio, a radiation pattern graph in the x-z plane, and a radiation pattern graph in the y-z plane, respectively, of the slot antenna of the second embodiment of the present invention. It is known from FIGS. 7A and 7B that impedance bandwidth of reflection coefficient lower than −10 dB is in the range from 2.16 GHz to 2.86 GHz (28.0%), while the axial radiation bandwidth of axial ratio lower than 3 dB is in the range from 2.12 GHz to 3.0 GHz (34.4%). Additionally, it is known from FIGS. 7C and 7D that radiation of the slot antenna is bi-directional. The left-handed circularly polarized wave may be generated by the slot antenna in the region of z>0, while the right-handed circularly polarized wave may be generated by the slot antenna in the region of z<0, with circular polarization bandwidth is in the range from 2.16 GHz to 2.86 GHz (28.0%). It can be seen that the design specification of WLAN 2.45 GHz frequency band is met for all the slot antennas of the first embodiment, the second embodiment, and the third embodiment of the present invention.

In the practical operation, parameters related to an antenna to be designed are inputted to a computer for finding the end points of the slot antenna complying with the design specification of WLAN 2.45 GHz frequency band via the optimization algorithm together with software of full wave electromagnetic simulation with self-designed program, or antenna design software, such as High Frequency Structure Simulation (abbreviated as HFSS) software, IE3D software and FEKO software, for example. In the present invention, the in-house designed PSO is taken as an example of the optimization algorithm This algorithm is allowed for finding the optimized result via bionic technology. For instance, one individual in a flock of birds is considered as a particle. Individual memory and experience may be possessed by each particle. When several particles are moved in flocks simultaneously, the best flight path is found by cross comparison with each other based on individual experience. In the practical procedure, the number of end points and optimized range of coordinates of each end point for antenna to be designed are established firstly. Subsequently, the coordinates of each end point are generated randomly within the optimized range for the particle. Subsequently, the coordinates of each end point being optimum at present and corresponding to the slot antenna are computed via the PSO, while the full wave electromagnetic simulation is performed with respect to the slot antenna to generate an adaptive value corresponding to the slot antenna in the computed result. The adaptive value is a parameter related to the antenna to be designed, such as reflection coefficient and axial ratio of the antenna, for example. In this case, multiple iterations are performed in the PSO. In the process of computing, the coordinates of each end point are varied on the basis of the adaptive value in each computation, and an optimal solution of the present computation is then obtained after the iterative operation is completed. The optimal solution is comprised of the coordinates of each end point of the slot antenna.

The detailed procedure for the computation of the adaptive value, in terms of reflection coefficient, is described as follows. In the frequency band between 2.3 GHz and 2.6 GHz, computing a range value over −10 dB as well as adding the range value and the adaptive value together are performed, if reflection coefficient is higher than −10 dB; nevertheless, computing the range value as well as adding the adaptive value are not performed, if reflection coefficient is lower than −10 dB. The criterion for determining whether antenna design is advantageous, only −10 dB taken as an example in the above, may be adjusted, e.g., to −12 dB as a stricter criterion for antenna design, in accordance with the actual need, and thus not limited to the example in the this disclosure. As far as axial ratio is concerned, in the frequency band between 2.3 GHz and 2.6 GHz, computing a range value over 3 dB as well as adding the range value and the adaptive value together are performed, if axial ratio is higher than 3 dB; nevertheless, computing the range value as well as adding the adaptive value are not performed, if axial ratio is lower than 3 dB. In this connection, the PSO is allowed for determining degrees of goodness/badness of each solution in each computation on the basis of the above adaptive value. The larger the adaptive value is, the worse the solution is. On the contrary, the smaller the adaptive value is, the better the solution is. After multiple iterations, an optimal solution, corresponding to the coordinates of each end point, is found.

To sum up, the optimization algorithm is adopted in this disclosure to define the shape of the irregular polygonal slot. In this connection, only computing is required and the process of computing is fully automatic, without relying on experience on antenna design and manual adjustment of the designer, in the design procedure of antenna. Moreover, the irregular polygonal slot designed via the optimization algorithm should not be intentionally extended in the manner of regular shape. Therefore, relatively lower difficulty in manufacture with relatively higher freedom in design of the slot antenna of this disclosure is achieved.

The embodiments of the present invention described above are intended to be merely exemplary and those skilled in the art shall be able to make numerous variations and modifications to it without departing from the spirit of the present invention. For example, the embodiments take circularly polarized antennas as examples, which involve complicated design considerations to meet the S11 and AR design specifications at the same time; however, in other embodiments, the present invention may also be applied to a linear polarized antenna, which design is less complicated than the circularly polarized antenna, and the present invention is not limited thereto.

What is claimed is:

1. A slot antenna, comprising:
a substrate provided with an upper surface and a lower surface corresponding to said upper surface;
an antenna portion comprising a ground layer provided on said upper surface, and an irregular polygonal slot passing through said ground layer and surrounded by said ground layer, said irregular polygonal slot being provided with a plurality of end points forming a plurality of slot edges therebetween, wherein the location of each end point is computed via an optimization algorithm so as to be predefined, such that said slot edges are not arranged in a regular orientation; and
a feed-in portion comprising a fed line provided on said lower surface.

2. The slot antenna according to claim 1, wherein said optimization algorithm is selected from the group consisting of Particle Swann Optimization, Genetic Algorithm, Ant Colony Optimization, Invasive Weed Optimization, Artificial Neural Network, Design of Experiments and Differential Evolution.

3. The slot antenna according to claim 1, wherein the number of said end points is in a range from 3 to 20.

4. The slot antenna according to claim 1, wherein the number of said end points is in a range from 5 to 8.

5. The slot antenna according to claim 1, wherein said substrate is a glass fiber substrate or a ceramic substrate.

6. The slot antenna according to claim 1, wherein the shape of said substrate is selected from the group consisting of a rectangle, a circle and a triangle.

7. The slot antenna according to claim 1, wherein each of said ground layer and said fed line is a thin layer of metal.

8. The slot antenna according to claim 1, wherein said fed line is of the kind of a microstrip-fed line or a coplanar waveguide-fed line.

9. The slot antenna according to claim 1, wherein said feed-in portion further comprises a SMA connector provided at one side of said substrate, while electrically connected to one end of said embodiment fed line far away from said irregular polygonal slot and to said ground layer, respectively.
